(19) United States
(12) Patent Application Publication
(10) Pub. No.: US 2007/0026933 A1
(43) Pub. Date: Feb. 1, 2007

(54) Gaming machine

(75) Inventor: Tatsuhiko Tanimura, Koto-ku (JP)

Correspondence Address: NDQ&M WATCHSTONE LLP, 1300 EYE STREET, NW, 400 EAST TOWER, WASHINGTON, DC, 20005, US

(73) Assignee: Aruze Corp., Koto-ku (JP)

(21) Appl. No.: 11/494,587

(22) Filed: Jul. 28, 2006

(30) Foreign Application Priority Data
Apr. 25, 2005 (JP) JP2005-126817

(51) Int. Cl. A63F 13/00

(52) U.S. Cl. 463/20

(57) ABSTRACT

A gaming machine includes a CPU and first to fifth variable display portions. The CPU variably or statically displays symbols on the first to fifth variable display portions. When three or more symbols of “HUNTER” are statically displayed, the CPU makes a shift from a base game to a bonus game. In the bonus game, when the three or more symbols of “HUNTER” are statically displayed among the symbols statically displayed on the variable display portions, the CPU continues a game period of the bonus game. In the bonus game, when at least one symbol of “HUNTER” is statically displayed on the first variable display portion, the CPU replaces symbols other than the symbol of “HUNTER”, which are statically displayed on the first variable display portion, by the symbols of “HUNTER”, thereby continuing the game period of the bonus game.

### CROSS-REFERENCE TO RELATED APPLICATION

This application is based upon the prior Japanese Patent Application No. 2005-126817, filed on Apr. 25, 2005, the entire contents of which are incorporated herein by reference.

### BACKGROUND OF THE INVENTION

1. Field of the Invention

The present invention relates to a gaming machine configured to allow a player to play a game according to a plurality of gaming modes including a base gaming mode and a special gaming mode. More specifically, the present invention relates to a gaming machine configured to replace one or more symbols other than a special symbol by one or more special symbols, the one or more symbols being displayed on a variable display portion on which the special symbol is statically displayed, and then display a predetermined number of special symbols on the variable display portion, when the special symbol is statically displayed on the variable display portion in a state the game is executed according to the special gaming mode.

2. Description of the Related Art

A conventional gaming machine such as a slot machine or a card game machine starts a game when a game medium such as a medal is inserted thereinto, and displays a result of the game based on a lottery result of an internal lottery performed in the gaming machine. For example, the slot machine statically displays predetermined symbols on one or more paylines. The card game machine displays a type of a drawn card. Then, such a gaming machine pays out a predetermined amount of game media based on a result of the game concerned.

In the conventional gaming machine, in general, the game is composed of a plurality of gaming modes so as not to allow the game to be monotonous, and at predetermined timing, the game is switched from one gaming mode to another gaming mode. For example, Japanese Patent Laid-Open Publication No. 2004-329297 discloses a gaming machine configured to shift a game from a base game to a bonus game when three or more trigger symbols are statically displayed adjacent to one another. When the game is shifted from the base game to the bonus game, the gaming machine allows a player to play the bonus game a predetermined number of times. In the first bonus game, with regard to a reel which displays each trigger symbol, the gaming machine replaces a regular reel by a re-lottery reel, and than statically displays the same drawn symbols entirely on the re-lottery reels. In the second bonus game and after, with regard to the reel which statically displayed the same symbol as the symbol displayed on the re-lottery reel, the gaming machine replaces the regular reel by the re-lottery reel, and statically displays the same drawn symbols entirely on the re-lottery reels. In the bonus game, as the number of re-lottery reels is being increased, odds of each symbol rise.

In the above-described gaming machine, the reel is changed from the regular reel to the re-lottery reel in each bonus game, and a game in which expectations of the player are enhanced is thus realized. However, in the above-described gaming machine, in each bonus game, a display state of the symbols is fixed after the symbols are statically displayed, and accordingly, the expectations of the player cannot be maintained. However, the above-described gaming machine does not perform an effect display when the game is shifted from one gaming mode (base mode) to the other gaming mode (bonus mode), and accordingly, an entertainment factor cannot be increased.

It is an object of the present invention to provide a gaming machine configured to continue a game period of a special gaming mode to enhance expectations of a player for the game and allow the player to play a variety of games.

In order to achieve the above-described object, the present invention provides a gaming machine comprising a display and a processor. The display is configured to variably display a plurality of symbols. The processor is operably coupled to at least one of the display and a memory. Further, the processor statically displays the plurality of symbols on the display, executes a game according to a plurality of gaming modes including a base gaming mode and a special gaming mode which gives a player a condition more advantageous than a condition of the base gaming mode, and replaces, by one or more special symbols, one or more symbols equivalent to the number of insufficient special symbols required for continuing a game period of the special gaming mode, from among one or more displayed symbols except for one or more special symbols statically displayed on the display, in the special gaming mode, and continuing the game period of the special gaming mode.

According to the present invention, in the special gaming mode, when one or more special symbols are statically displayed on the display, one or more symbols except for the one or more displayed special symbols, which are statically displayed on the display, are replaced by one or more special symbols, and the game period of the special gaming mode is continued. Therefore, the gaming machine enhances expectations of a player for the continuation of the special game while the special game is being executed. As a result, the gaming machine further enhances the expectations of the who plays the special game, and enhances a gaming will thereof. Moreover, the gaming machine never bores the player by using a variety of effects in which the symbols stopped once are changed to the special symbols.

In order to achieve the above-described object, the present invention provides a gaming machine comprising a display and a processor. The display is configured to variably display a plurality of symbols. The processor is operably coupled to at least one of display and a memory. Further, the processor statically displays the plurality of symbols on the display, executes a game according to a plurality of gaming modes including a base gaming mode a special gaming mode which gives a player a condition more advantageous than a condition of the base gaming mode, and replaces, by one or more special symbols, one or more symbols equivalent to the number of insufficient special symbols required for shifting the gaming mode to the special gaming mode, from among one or more displayed symbols except for one or more special symbols statically displayed on the display, in the base gaming mode, and shifting the gaming mode from the base gaming mode to the special gaming mode.

According to the present invention, in the bass gaming mode, when one or more special symbols are statically displayed on the display, one or more symbols except for the one or more displayed special symbols, which are statically displayed on the display, are replaced by one or more special symbols, and the game is shifted to the special gaming mode. Therefore, the gaming machine enhances expectations of a player for the transition from the base gaming mode to the special gaming mode more advantageous for the player. As a result, the gaming machine further enhances the expectations of the player who plays the base game, and enhances the gaming will thereof. Moreover, the gaming machine never bores the player by using the variety of effects in which the symbols stopped once are changed to the special symbols.

In order to achieve the above described object, the present invention provides a gaming machine comprising a display and a processor. The display configured to variably display a plurality of symbols. The processor is operably coupled to at least one of the display and a memory. Further, the processor statically displays the plurality of symbols on the display, executes a game according to a plurality of gaming modes including a base gaming mode and a special gaming mode which gives a player a condition more advantageous than a condition of the base gaming mode, and replaces, by one or more special symbols, one or more symbols equivalent to the number of insufficient special symbols required for continuing a game period of the special gaming mode, from among one or more displayed symbols except for one or more special symbols statically displayed on the display, in the special gaming mode, displays an image associated with the special symbols on the display on which the replaced special symbols are displayed, and continues the game period of the special gaming mode.

According to the present invention, in the special gaming mode, one or more special symbols are statically displayed on the display, one or more symbols except for the one or more displayed special symbols, which are statically displayed on the display, are replaced by one or more special symbols, an image associated with the special symbols is displayed on the display, and the game period of the special gaming mode is continued. Therefore, the gaming machine enhances expectations of a player for the continuation of the special game while the special game is being executed. As a result, the gaming machine further enhances the expectations of the player who plays the special game, and enhances a gaming will thereof. Moreover, the gaming machine never bores the player by using a variety of effects in which the symbols stopped once a changed to the special symbols.

### BRIEF DESCRIPTION OF THE DRAWINGS

FIG. 1 is a perspective view of a slot machine according to a first embodiment of the present invention.

FIG. 2 is a front view of variable display portions of the slot machine according to the first embodiment of the present invention.

FIG. 3 is a front view of an operation table of the slot machine according to the first embodiment of the present invention.

FIG. 4 is a schematic view showing columns of symbols to be variably displayed on the variable display portions by first to fifth reel bands according to the first embodiment of the present invention.

FIG. 5 is a block diagram of a control system of the slot machine according to the first embodiment of the present invention.

FIG. 6 is a block diagram of a liquid crystal driving circuit of liquid crystal displays according to the first embodiment of the present invention.

FIG. 7 is a view showing a storage area of a ROM according to the first embodiment of the present invention.

FIG. 8 is a payout table showing winning combinations and payouts of the winning combinations according to the first embodiment of the present invention.

FIG. 9 is a flowchart of a main process program in the slot machine according to the first embodiment of the present invention.

FIG. 10 is a flowchart of a start receiving process program in the slot according to the first embodiment of the present invention.

FIG. 11 is a flowchart of a lottery process program in the slot machine according to the first embodiment of the present invention.

FIG. 12 is a flowchart of a base game process program in the slot machine according to the first embodiment of the present invention.

FIG. 13 is a flowchart of a bonus game process program in the slot machine according to the first embodiment of the present invention.

FIG. 14 is a flowchart of a sub-process program of a symbol replacement attraction process in the slot machine according to the first embodiment of the present invention.

FIG. 15 is a view showing first to fifth variable display portions when “HUNTER” as a trigger symbol is displayed on the first variable display portion.

FIG. 16 is a view showing the first to fifth variable display portions a symbols displayed on the first variable display portion are replaced by the symbols of “HUNTER” in a process of Step S71.

FIG. 17 is a view showing a moving image effect where an enlarged symbol of “HUNTER” displayed on the first variable display portion shoots an image of a target game displayed on the fifth variable display portion in a process of Step S73.

FIG. 18 is a view showing the first to fifth variable display portions when a bonus winning screen is displayed in a process of Step S74.

FIG. 19 is a flowchart of a main process program in a slot machine according to a second embodiment of the present invention.

FIG. 20 is a flowchart of a lottery process program in a slot machine according to a third embodiment of the present invention.

FIG. 21 is a winning a combination lottery table according to the third embodiment of the present invention.

### DESCRIPTION OF THE PREFERRED EMBODIMENTS

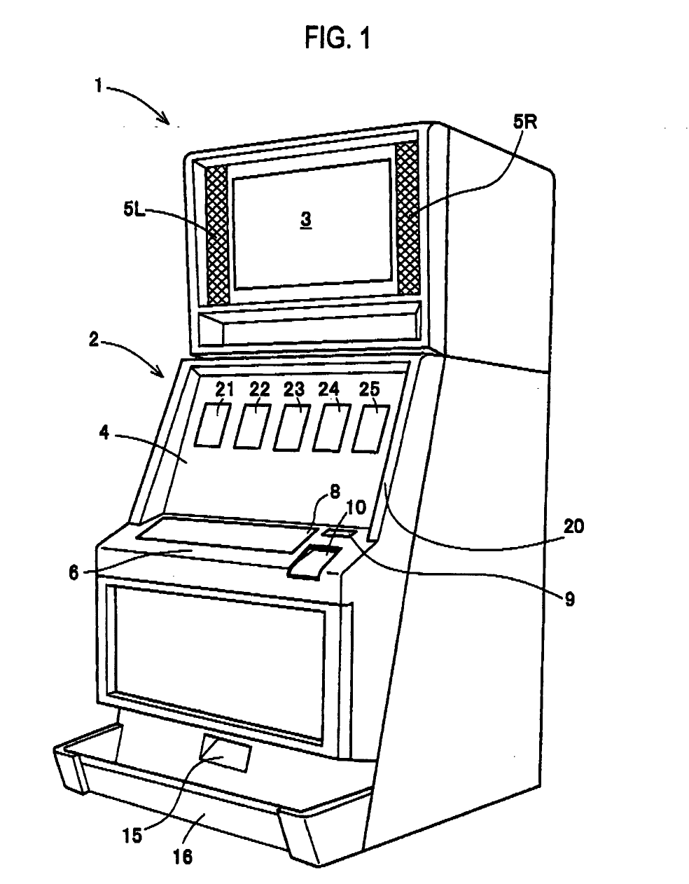

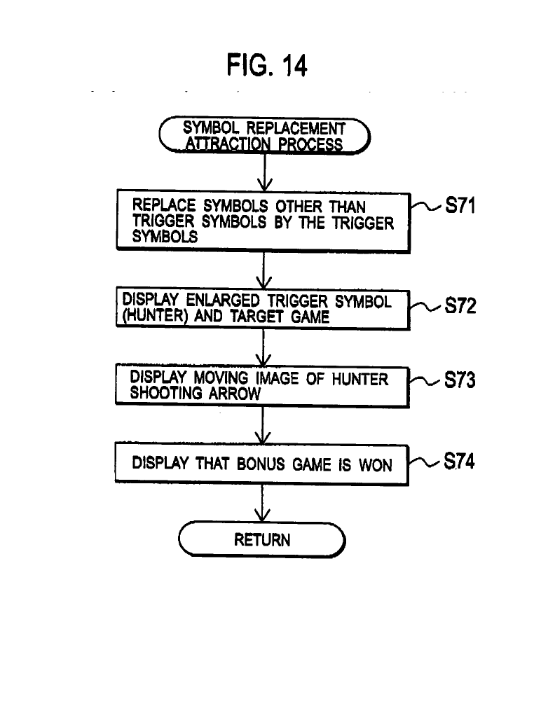

A description will be made below in detail of first to third embodiments of the present invention while referring to FIG. 1 to FIG. 21.

### First Embodiment

A slot machine 1 is a video slot a machine which includes an image display device such as a liquid crystal display, and allows a player to play a game by variably and statically displaying images of various symbols on the image display device. It is noted that the various symbols may be mounted on one or more mechanical reels and may be variably or statically displayed by rotating or stopping the mechanical reels.

As shown in FIG. 1, the slot machine 1 includes a cabinet 2, an upper liquid crystal display 3, a lower liquid crystal display 4, speakers 5L and 5R, an operation table 6, an operation panel 8, a coin insertion portion 9, a bill insertion portion 10, a coin payout port 15, a coin receiving portion 16, and an instrument front panel 20. The cabinet 2 forms the entirety of the slot machine 1. On an upper portion of a front face of the cabinet 2, the upper liquid crystal display 3 is disposed. On the instrument front panel 20 provided on a center portion of the front face of the cabinet 2, the lower liquid crystal display 4 is disposed. The upper liquid crystal display 3 and the lower liquid crystal display 4 are composed of generally used liquid crystal displays.

The pair of speakers 5L and 5R are provided on the right and left sides of the upper liquid crystal display 3, and outputs predetermined BGM, voice, sound effect, and the like to a player based on a gaming mode of the slot machine 1. Under the lower liquid crystal display 4, the operation table 6 which protrudes frontward is provided. On the operation table 6, there are provided, in an order from the left, the operation panel 8 on which various buttons are arranged, the coin insertion portion 9 into which a game medium such as a coin is inserted, and the bill insertion portion 10 into which a bill is inserted.

The upper liquid crystal display 3 displays information regarding a game such as a game method, types of winning combinations and payouts of the respective winning combinations, and a variety of effects. The lower liquid crystal display 4 displays the number of credits currently owned by a player and a variety of effect images. On the vicinity of the center of the lower liquid crystal display 4, first to fifth variable display portions 21, 22, 23, 24 and 25 are displayed. The first to fifth variable display portions 21, 22, 23, 24 and 25 variably display a variety of symbols downward, and statically display a predetermined combination of the symbols after an elapse of a predetermined time.

The slot machine 1 is a video slot machine which allows a player to play a slot game composed of two types of game modes, which are a base game and a bonus game, by using video reels displayed on the first to fifth variable display portions 21, 22, 23, 24 and 25 of the lower liquid crystal display 4. Note that, in the slot game according to the first embodiment, the number of the symbols statically displayed on each of the first to fifth variable display portions 21, 22, 23, 24 and 25 is three.

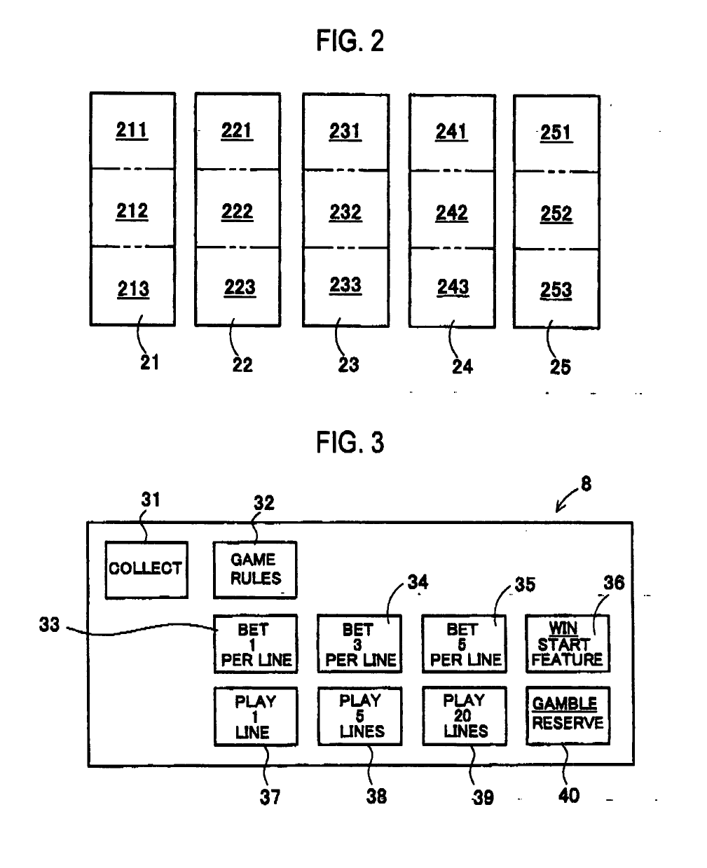

Specifically, as shown in FIG. 2, the first to fifth variable display portions 21, 22, 23, 24 and 25 are individually partitioned into first static display region 211, 221, 231, 241 and 251, second static display regions 212, 222, 232, 242 and 252, and third static display regions 213, 223, 233, 243 and 253. On the static display regions 211 to 213, 221 to 223, 231 to 233, 241 to 243 and 251 to 253, predetermined symbols are statically displayed based on a lottery result of an internal lottery.

In the slot game, there are twenty paylines each of which is formed of five static display regions among the static display regions 211 to 213, 221 to 223, 231 to 233, 241 to 243 and 251 to 253. When specific symbols are statically displayed in a specific mode on an activated payline, the slot machine 1 pays a payout to a per.

A first payline L1 is formed of the second static display regions 212, 222, 232, 242 and 252. A second payline L2 is formed of the first static display regions 211, 221, 231, 241 and 251. A third payline L3 is formed of the third static display regions 213, 223, 233, 243 and 253. In a similar way, the respective fourth to twentieth paylines L4 to L20 are formed by using the static display regions 211 to 213, 221 to 223, 231 to 233, 241 to 243, and 251 to 253. Note that paylines activated based on operations of the respective bet buttons (a BET 1 PER LINE button 33, a BET 3 PER LINE button 34, and a BET 5 PER LINE button 35) are referred to as “activated paylines”.

Moreover, on the operation panel 8 provided on the operation table 6, a variety of operation buttons are arranged. As shown in FIG. 3, on an upper stage of the operation panel 8, a COLLECT button 31 and a GAME RULES button 32 arm arranged in an order from the most left side. On a middle stage of the operation panel 8, the BET 1 PER LINE button 33, the BET 3 PER LINE button 34, the BET 5 PER LINE button 35, and a WIN START FEATURE button 36 are arranged in an order from the most left side. On a lower stage of the operation panel 8, a PLAY 1 LINE button 37, a PLAY 5 LINES button 38, a PLAY 20 LINES button 39, and a GAMBLE RESERVE button 40 are arranged in an order from the most left side.

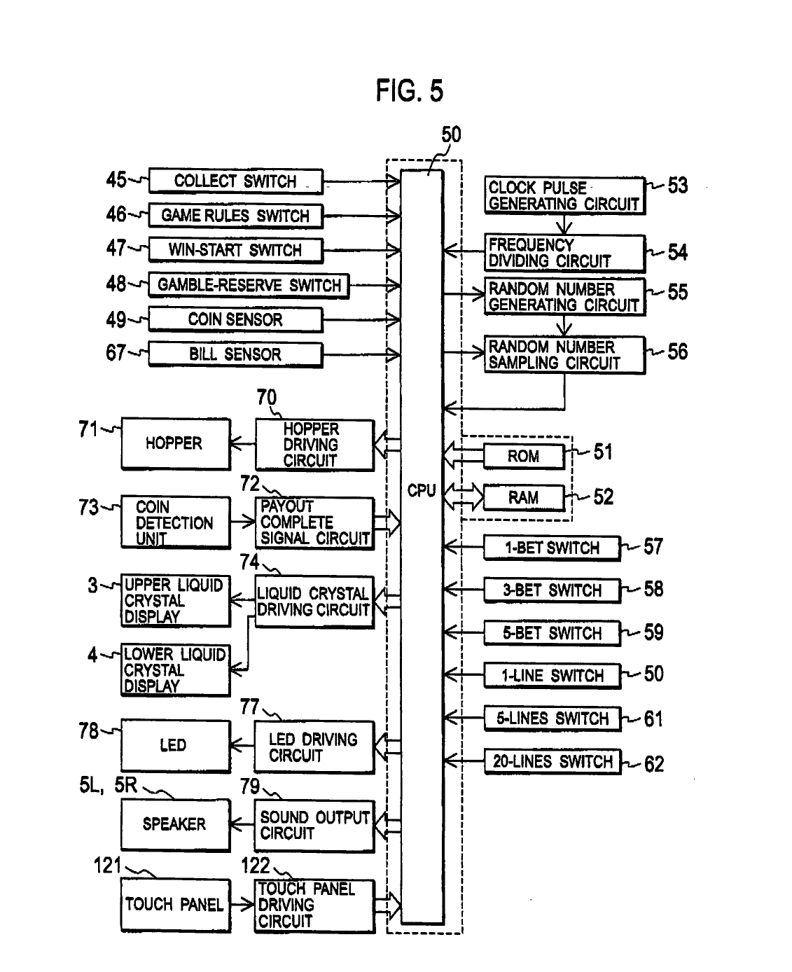

The COLLECT button 31 is a button usually depressed at the time when the game is ended. When the COLLECT button 31 is depressed, coins equivalent to the number of credits acquired in the game are paid out from the coin payout port 15 through a hopper (not shown) provided in an inside of the slot machine 1. A switch 45 is additionally provided to the COLLECT button 31, and based on the depression of the COLLECT button 31, a switching signal is outputted to a CPU 50 (refer to FIG. 5).

The GAME RULES button 32 is a button depressed when an operation method of the game and the like are unknown. When the GAME RULES button 32 is depressed, various pieces of HELP information are displayed on the upper liquid crystal display 3 and the lower liquid crystal display 4. A GAME RULES switch 46 is additionally provided to the GAME RULES button 32, and based on the depression of the GAME RULES button 32, a switching signal is outputted from the RULES switch 46 to the CPU 50 (refer to FIG. 5).

The BET 1 PER LINE button 33 is a button of which every depression allows the credits currently owned by a player to be bet one by one for each of the activated paylines. A 1-BET switch 57 is additionally provided to the BET 1 PER LINE button 33. When the BET 1 PER LINE button 33 is depressed, a switching signal is outputted from the 1-BET switch 57 to the CPU 50 based on the depression (refer to FIG. 5).

The BET 3 PER LINE button 34 is a button for starting, based on depression thereof, the game on a 3-BET basis for each of the activated paylines. A 3-BET switch 58 is additionally provided to the BET 3 PER LINE button 34. When the 3-BET switch 58 is depressed, a switching signal is outputted therefrom to the CPU 50 (refer to FIG. 5).

The BET 5 PER LINE button 35 is a button for starting, based on depression thereof, the game on a 5-BET basis for each of the activated paylines. A 5-BET switch 59 is additionally provided to the BET 5 PER LINE button 35. When the 5-BET switch 59 is depressed, a switching signal is outputted therefrom to the CPU 50 (refer to FIG. 5).

The WIN START FEATURE button 36 is a button for starting the bonus game and adding payouts acquired in the bonus game to the credits. A WIN-START switch 47 is additionally provided to the WIN START FEATURE button 37. When the WIN-START switch 47 is depressed, a switching signal is outputted therefrom to the CPU 50 (refer to FIG. 5).

The PLAY 1 LINE button 37 is a button for starting the game based on depression thereof while setting the number of activated paylines at “1”. A 1-LINE switch 60 is additionally provided to the PLAY 1 LINE button 37. When the 1-LINE switch 60 is depressed, a switching signal is outputted therefrom to the CPU 50 (refer to FIG. 5).

The PLAY 5 LINES button 38 is a button for starting the game based on depression thereof while setting the number of activated paylines at “5”. A 5-LINES switch 61 is additionally provided to the PLAY 5 LINES button 38. When the 5-LINES switch 61 is depressed, a switching signal is outputted therefrom to the CPU 50 (refer to FIG. 5).

The PLAY 20 LINES button 39 is a button for starting the game based on depression thereof while setting the number of activated paylines at “20”. A 20-LINES switch 62 is additionally provided to the PLAY 20 LINES button 39. When the 20-LINES switch 62 is depressed, a switching signal is outputted therefrom to the CPU 50 (refer to FIG. 5).

Hence, based on the depressions of the PLAY 1 LINE button 37, the PLAY 5 LINES button 38, or the PLAY 20 LINES button 39, the number of activated paylines is decided.

When the PLAY 1 LINES button 37 is depressed, the first payline L1 is activated. When the PLAY 5 LINES button 38 is depressed, the first to fifth paylines L1 to L5 are activated. When the PLAY 20 LINES button 39 is depressed, the first to twentieth paylines L1 to L20 are activated.

Moreover, PLAY 1 LINE button 37, the PLAY 5 LINES button 38, or the PLAY 20 LINES button 39 variably display the symbols on the first to fifth variable display portions 21, 22, 23, 24 and 25 based on the depressions thereof in order to start the game using the current number of bets and the number of activated paylines concerned.

The GAMBLE button 40 is a button depressed when a player leaves the gaming machine or for shifting the game to a double down game after the bonus gum is ended. Here, the double down game is a game played by using the credits acquired in the bonus game, and details thereof are omitted. A GAMBLE-RESERVE switch 48 is additionally provided to the GAMBLE RESERVE button 40. When the GAMBLE-RESERVE switch 45 is depressed, a switching signal is outputted therefrom to the CPU 50 (refer to FIG. 5).

A coin sensor 49 is disposed in the coin insertion portion 9. When a coin is inserted into the coin insertion portion 9, a coin detection signal is outputted to the CPU 50 through the coin sensor 49 (refer to FIG. 5), and credits equivalent to the inserted coin are added. A bill sensor 67 is disposed in the bill insertion portion 10. When a bill is inserted into the bill insertion 10, a bill detection signal is outputted to the CPU 50 through the bill sensor 67 (refer to FIG. 5), and credits equivalent to the inserted bill is added.

On a lower portion of the cabinet 2, the coin payout port 15 is formed, and the coin receiving portion 16 which receives the coins paid out from the coin payout port 15 is provided. In an inside of the coin payout port 15, a coin detection unit 73 to be described later, which is composed of a hopper 71 capable of discharging the coins one by one, a sensor, and the like, is disposed (refer to FIG. 5). The coin detection unit 73 detects the number of coins paid out from the coin payout port 15. Note that a receipt in which the number (value) of coins is described may also be discharged instead of directly paying out the coins. In this case, a player takes the discharged receipt to a counter and the like of a game arcade, thus making it possible to exchange the receipt with a premium and the like.

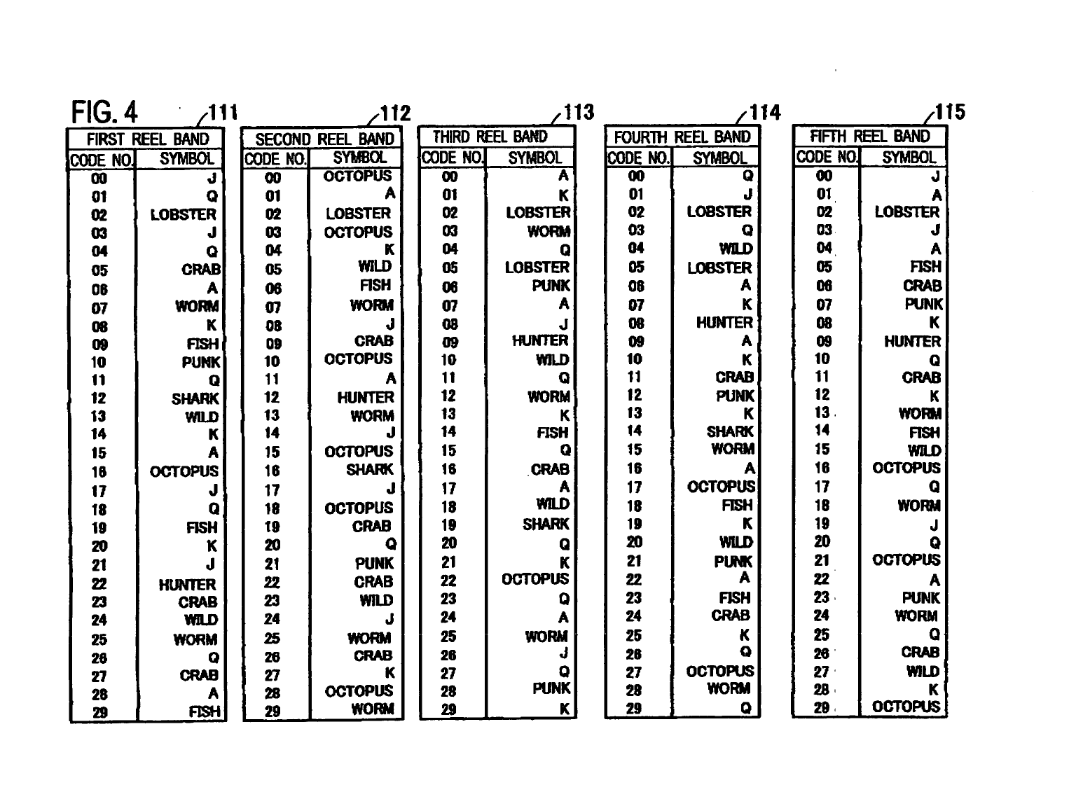

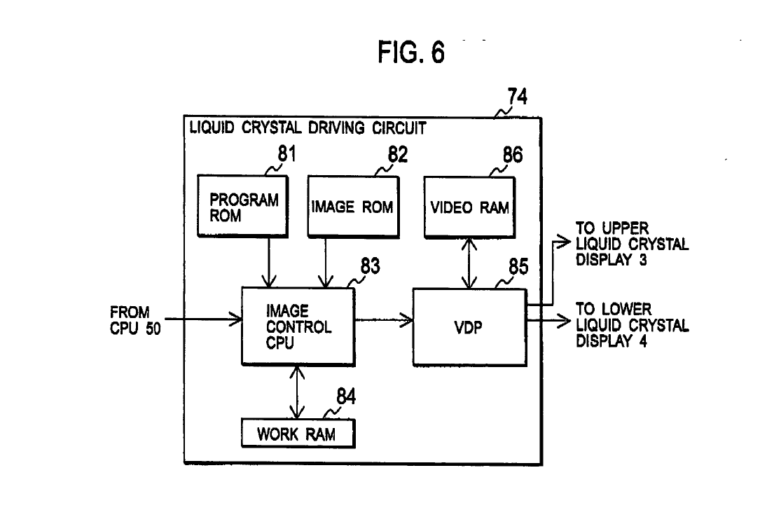

Next, a description will be made of examples of the symbols variably displayed on the first to fifth variable display portions 21, 22, 23, 24 and 25 of the lower liquid crystal display 4 when the base game and the bonus game are played. As shown in FIG. 4, a column of symbols, which is shown on a first reel band 111, is a column of the symbols variably displayed on the first variably display portion 21. A column of symbols, which is shown on a second reel band 112, is a column of the symbols variably displayed on the second variable display portion 22. A column of symbols, which is shown on a third reel band 113, is a column of the symbols variably displayed on the third variable display portion 23. A column of symbols, which is shown on a fourth reel band 114, is a column of the symbols variably displayed on the fourth variable display portion 24. A column of symbols, which is shown on a fifth reel band 115, is a column of the symbols variably displayed on the fifth variable display portion 25. Note that dot data for forming images of the respective columns of the symbols shown on the first to fifth reel bands 111, 112, 113, 114 and 115 are stored in an image ROM 82 (refer to FIG. 6).

The respective columns of the symbols, which are shown on the first to fifth reel bands 111, 112, 113, 114 and 115, have arrays of the symbols, which are different from one another. Each column of the symbols is composed by appropriately combining thirteen types of symbols which are “LOBSTER”, “SHARK”, “FISH”, “PUNK”, “OCTOPUS”, “CRAB”, “WORM”, “A”, “K”, “Q”, “J”, “WILD”, and “HUNTER”.

“LOBSTER” shows a symbol of a lobster, “SHARK”, “FISH”, “PUNK”, “OCTOPUS”, “CRAB”, “WORM”, and “HUNTER” show symbols of a shark, a fish, a person who holds a guitar, an octopus, a crab, a worm, and a hunter, respectively. “A”, “K”, “Q”, “J”, and “WILD” show symbols of English characters.

When the respective symbols of “LOBSTER”, “SHARK”, “FISH”, “PUNK”, “OCTOPUS”, “CRAB”, “WORM”, “A”, “K”, “Q”, and “J” are statically displayed by a predetermined number from the left end along the first to twentieth paylines L1 to L20, a predetermined number of credits are added to the credits owned by a player (refer to FIG. 8).

“HUNTER” is a scatter symbol. No matter which the activated payline may be, when two or more of symbols of “HUNTER” are displayed on the first to fifth variable display portions 21, 22, 23, 24 and 25, a predetermined number of credits are added to the credits owned by a player (refer to FIG. 8). Moreover, “HUNTER” is also a trigger symbol for making a shift (transition) from the base game to the bonus game. No matter which the activated payline may be, when three or more symbols of “HUNTER” are statically displayed on the first to fifth variable display portions 21, 22, 23, 24 and 25, the base game is shifted to the bonus game. “WILD” is a wild symbol serving as an alternative of the symbols other than “HUNTER” (scatter symbol).

When the game is started by the depression of any of the PLAY 1 LINE button 37, the PLAY 5 LINES button 38, and the PLAY 20 LINES button 39, in the respective columns of the symbols, which are shown on the first to fifth reel bands 111, 112, 113, 114 and 115, the symbols are scroll-displayed downward on the respective first to fifth variable display portions 21, 22, 23, 24 and 25. Then, after an elapse of a predetermined time, fifteen symbols are statically displayed. Moreover, a variety of winning combinations are preset based on combinations of the plurality of types of symbols. When a combination of the symbols, which corresponds to the winning combination, is stopped on the activated winning line, a payout is added to the credits in response to the winning combination. Furthermore, when three or more symbols of “HUNTER” are statically displayed at the same time no matter which the payline may be, the base game is shifted to the bonus game.

Next, a description will be made of a configuration of a control system of the slot machine 1. As shown in FIG. 5, the control system of the slot machine 1 includes the upper liquid crystal display 3, the lower liquid crystal display 4, the speakers 5L and 5R, the COLLECT switch 45, the GAME RULES switch 46, the WIN-START switch 47, the GAMBLE-RESERVE switch 48, the coin sensor 49, the CPU 50, a ROM 51, a RAM 52, a clock pulse generating circuit 53, a frequency dividing circuit 54, a random number generating circuit 55, a random number sampling circuit 56, the 1-BET switch 57, the 3-BET switch 58, the 5-BET switch 59, the 1-LINE switch 60, the 5-LINES switch 62, the 20-LINES switch 62, the bill sensor 67, a hopper driving circuit 70, the hopper 71, a payout complete signal circuit 72, the coin detection unit 73, a liquid crystal driving circuit 74, an LED driving circuit 77, an LED 78, a sound output circuit 79, a touch panel 121, and a touch panel driving circuit 122.

The control system of the slot machine 1 is basically composed while taking the CPU 50 as a main component. The ROM 51 and the RAM 52 are connected to the CPU 50. The ROM 51 stores a main process program, a base game process program, a bonus game process program, a symbol lottery table for drawing the statically display symbols, the winning combinations based on the statically displayed symbols, a payout table in which paid-out credits are set based on the winning combinations, and other various programs and data tables, which are necessary to control the slot machine 1. The RAM 52 temporarily stores various data arithmetically operated by the CPU 50.

The lock pulse generating circuit 53 which generates a reference clock pulse and the frequency dividing circuit 54 are connected to the CPU 50. Moreover, the random number generating circuit 55 which sequentially generates random numbers and the random numbers sampling circuit 56 are connected to the CPU 50. A random number sampled by the random number sampling circuit 56 is used for various lotteries for the winning combination and the like. To the CPU 50, there are connected the COLLECT switch 45 additionally provided to the COLLECT button 31, the GAME RULES switch 46 additionally provided to the GAME RULES button 32, the 1-BET switch 57 additionally provided to the BET 1 PER LNE button 33, the 3-BET switch 58 additionally provided to the BET 3 PER LINES button 34, the 5-BET switch 59 additionally provided to the BET 5 PER LINE button 35, the WIN-START switch 47 additionally provided to the WIN START FEATURE button 36, the 1-LINE switch 60 additionally provided to the PLAY 1 LINE button 37, the 5-LINES switch 61 additionally provided to the PLAY 5 LINES button 38, the 20-LINES switch 62 additionally provided to the PLAY 20 LINES button 39, and the GAMBLE RESERVE switch 48 additionally provided to the GAME-RESERVE button 40. The CPU 50 performs control to execute various operations corresponding to the above-described respective buttons based on the switching signals outputted from the respective switches by the depression of the respective buttons.

To the CPU 50, there are connected the coin sensor 49 disposed in the coin insertion portion 9, and the bill sensor 67 disposed in the bill insertion portion 10. Upon detecting the coins inserted from the coin insertion portion 9, the coin sensor 49 outputs the coin detection signal to the CPU 50. The CPU 50 arithmetically operates the number of inserted coins based on the coin detection signal. Upon detecting the type and amount of bill inserted from the bill insertion portion 10, the bill sensor 67 outputs the bill detection signal to the CPU 50. The CPU 50 arithmetically operates the number of credits equivalent to the amount of bill based on the bill detection signal.

The hopper 71 is connected to the CPU 50 through the hopper driving circuit 70. When a drive signal is outputted from the CPU 50 to the hopper driving circuit 70, the hopper 71 pays out a predetermined number of coins from the coin payout port 15. The coin detection unit 73 is connected to the CPU 50 through the payout complete signal circuit 72. The coin detection unit 73 is disposed in the inside of the coin payout port 15. Upon detecting that the predetermined number of coins are paid out from the coin payout port 15, the coin detection unit 73 outputs a coin payout detection signal to the payout complete signal circuit 72. Upon receiving the coin payout detection signal, the payout complete signal circuit 72 outputs a payout complete signal to the CPU 50. The upper liquid crystal display 3 and the lower liquid crystal display 4 are connected to the CPU 50 through the liquid crystal driving circuit 74. The CPU 50 controls the upper liquid crystal display 3 and the lower liquid crystal display 4.

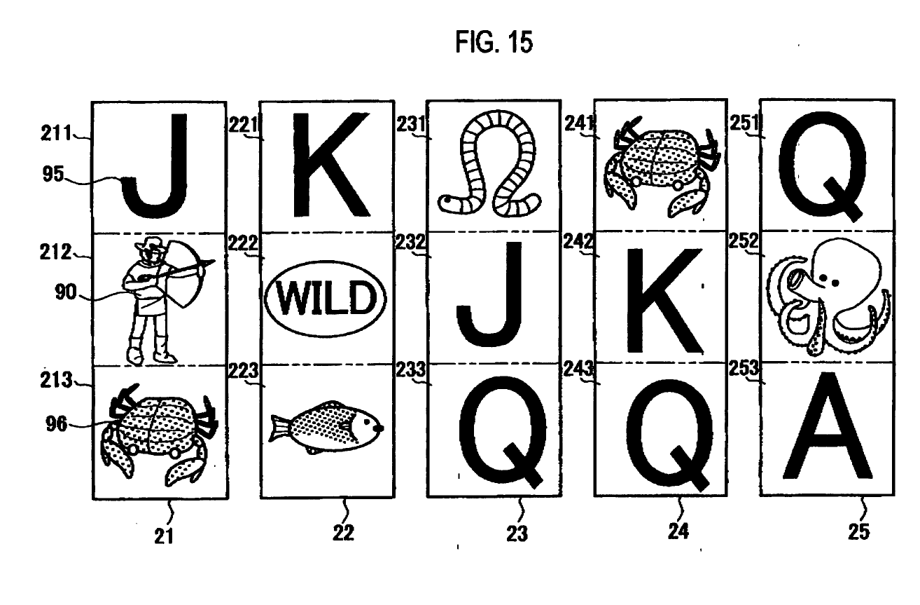

As shown in FIG. 6, the liquid crystal driving circuit 74 is composed of a program ROM 81, an image ROM 82, an image control CPU 83, a work RAM 84, a video display processor (VDP) 85, a video RAM 86, and the like. The program ROM 81 stores an image control program regarding display on the upper liquid crystal display 3 and the lower liquid crystal display 4, and various selection tables. The image ROM 82 stores the dot data for forming images such as, for example, the symbols on the first to fifth reel bonds 111, 112, 113, 114 and 115, and effect images (refer to FIG. 15 to FIG. 18) of a hunter and a target game, which are displayed on the first variable display portion 21 and the fifth variable display portion 25, the above-described symbols and the effect images being displayed on the lower liquid crystal display 4 (or the first to fifth variable display portions 21, 22, 23, 24 and 25).

The image control CPU 83 decides the images to be displayed on the upper liquid crystal display 3 and the lower liquid crystal display 4 from the dot date prestored in the image ROM 82 according to the image control program prestored in the program ROM 81 based on a parameter set by the CPU 50. The work RAM 84 is a temporal storing means employed when the image control program is executed in the image control CPU 83. The VDP 85 generates images corresponding to display contents decided by the image control CPU 83, and outputs the images to the upper liquid crystal display 3 or the lower liquid crystal display 4. Thus, for example, the respective columns of the symbols shown on the first to fifth reel bands 111, 112, 113, 114 and 115 are variably displayed on the first to fifth variable display portions 21, 22, 23, 24 and 25. The video RAM 86 is a temporal storing means employed when the images are formed by the VDP 85.

The LED 78 is connected to the CPU 50 through the LED driving circuit 77. The LED 78 is controlled to be turned on by the LED driving circuit 77 based on the drive signal from the CPU 50 when a large number thereof is arrayed on the front face of the slot machine 1 and performs the variety of effects. In particular, in the slot machine 1, the LED 78 is turned on at the time of the bonus game, and so on, thereby augmenting the effect.

The sound output circuit 79 and the speakers 5L and 5R are connected to the CPU 50. The speakers 5L and 5R output the voice and the sound effect when the variety of effects are performed based on an output signal from the sound output circuit 79.

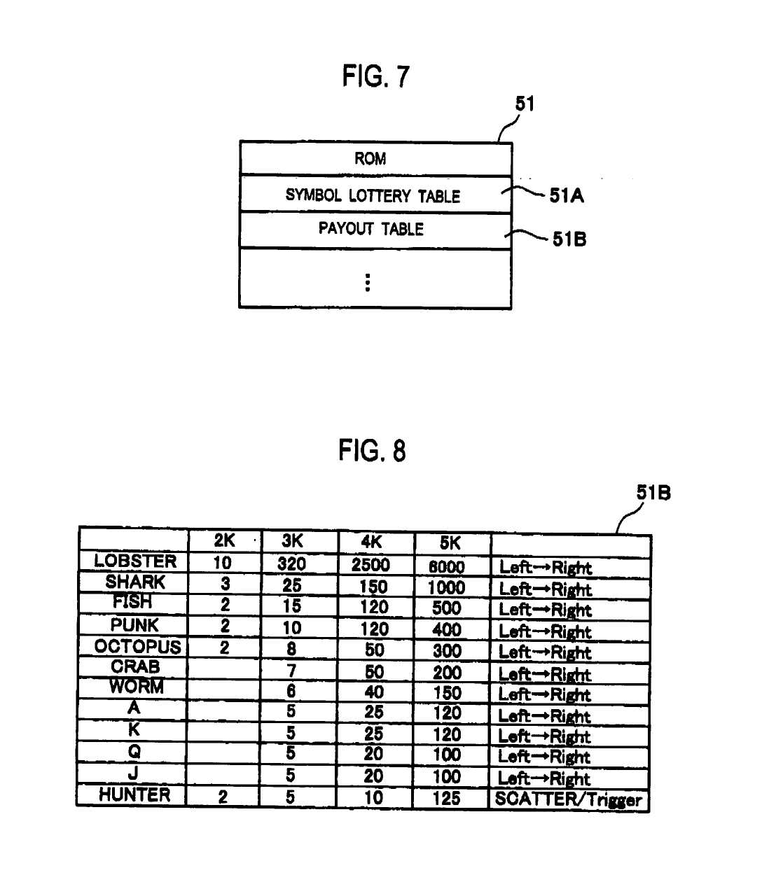

As shown in FIG. 7, the ROM S1 stores a symbol lottery table 51A employed when are decides the symbols to be statically displayed on the static display regions 211 to 213, 221 to 223, 231 to 233, 241 to 243, and 251 to 253 of the first to fifth variable display portions 21, 22, 23, 24 and 25 based on random number values, and a payout table 51B (refer to FIG. 7) which stores winning combinations of the symbols statically displayed on the respective static display regions and payouts of the winning combinations.

Next, a description will be made of the symbol lottery table 51A which is stored in the ROM 51 and is used when the symbols to be statically displayed on the static display regions 211 to 213, 221 to 223, 231 to 233, 241 to 243, and 251 to 253 are decided in the case where the base game and the bonus game are played by using the first to fifth variable display portions 21, 22, 23, 24 and 25 in the slot machine 1.

The symbol lottery table 51A is a lottery table employed when are drawn the symbols stopped on the first activated payline L1 composed of the second static display regions 212, 222, 232, 242 and 252 based on the random number values sampled by the random number sampling circuit 56. Upon deciding the symbols to be stopped on the second static display regions 212, 222, 232, 242 and 252, the CPU 50 decides the symbols to be statically displayed on the first and third static display regions 211, 213, 221, 223, 231, 233, 241, 243, 251 and 253, which are located on and under the second static display regions, from the arrays of the symbols on the respective reel bands. Specifically, the symbols having code numbers smaller by one than code numbers decided based on the random number values are statically displayed on the first static display regions 211, 221, 231, 241 and 251, and the symbols having code numbers larger by one than the decided code numbers concerned are statically displayed on the third static display regions 213, 223, 233, 243 and 253.

In the slot machine 1, the symbols to be statically displayed on the activated payline L1 are decided for each of the first to fifth variable display portions 21, 22, 23, 24 and 25. The symbol lottery table 51A individually assigns the code numbers of “0” to “29” to the symbols of the columns, who are displayed on the first to fifth reel bands 111, 112, 113, 114 and 115, in a descending order, and meanwhile, sets the random number values corresponding to the respective code numbers.

At the time when the game is started, the CPU 50 samples five random number values individually corresponding to the first to fifth variable display portions 21, 22, 23, 24 and 25 by the random number sampling circuit 56, and decides the symbols to be stopped on the second static display regions 212, 222, 232, 242 and 252 for each of the first to fifth variable display regions 21, 22, 23, 24 and 25. For example, when the sampled random number value is “9”, the CPU 50 statically displays the symbol of “FISH” assigned to the code number “09” on the second static region.

Next, a description will be made of the winning combinations and the payouts of the winning combinations when the base game and the bonus game are played in the slot machine 1. FIG. 8 is the payout table 51B which shows the winning combinations and the payouts of the winning combinations when the game is played using the first to fifth variable display portions 21, 22, 23, 24 and 25. FIG. 8 shows the payouts when the number of bets is “1”. Values of the payouts shown in FIG. 8 are added to the credits. When the number of bets is “2” or more, values obtained by multiplying the values of the payouts shown in FIG. 8 by the number of bets concerned are added to the credits.

As in FIG. 8, when a plurality of the symbol of “LOBSTER” are statically displayed continuously on the activated payline on the first and second variable display portions 21 and 22 (in the case of “2K” where two symbols of “LOBSTER” appear continuously from the left end), a player obtains a payout of “10”. When a plurality of the symbols of “LOBSTER” are statically displayed continuously on the activated payline on the first to third variable display ports 21, 22 and 23 (in the case of “3K” where three symbols of the “LOBSTER” appear continuously from the left end), the player obtains a payout of “320”. When a plurality of the symbols of “LOBSTER” are statically displayed continuously on the activated payline on the first to fourth variable display portions 21, 22, 23 and 24 (in the case of “4K” where four symbols of the “LOBSTER” appear continuously from the left end), the player obtains a payout of “2500”. When a plurality of the symbols of “LOBSTER” are statically displayed continuously on the activated payline on the first to fifth variable display portions 21, 22, 23, 24 and 25 (in the case of “5K” where five symbols of the “LOBSTER” appear continuously from the left end), the player obtains a payout of “6000”.

When a plurality of the symbols of “SHARK” are statically displayed continuously on the activated payline on the first and second variable display portions 21 and 22 (in the game of “2K” when two symbols of “SHARK” appear continuously from the left end), the player obtains a payout of “3”. When a plurality of the symbols of “SHARK” are statically displayed continuously on the activated payline on the first to third variable display portions 21, 22 and 23 (in the case of “3K” where three symbols of “SHARK” appear continuously from the left end), the player obtains a payout of “25”. When a plurality of the symbols of “SHARK” are statically displayed continuously on the activated payline on the first to fourth variable display portions 21, 22, 23 and 24 (in the case of “4K” are four symbols of “SHARK” appear continuously from the left end), the player obtains a payout of “150”. When a plurality of the symbols of “SHARK” are statically displayed continuously on the activated payline on the first to fourth variable display portions 21, 22, 23 and 24 (in the case of “4K” where four symbols of “SHARK” appear continuously from the left end), the player obtains a payout of “150”. When a plurality of the symbols of “SHARK” are statically displayed continuously on the activated payline on the first to fifth variable display portions 21, 22, 23, 24 and 25 (in the case of “5K” where five symbols of “SHARK” appear continuously from the left end), the player obtains a payout of “1000”.

In a similar way to the above, payouts shown in FIG. 8 are also set for the symbol of “FISH”, the symbol of “PUNK”, the symbol of “OCTOPUS”, the symbol of “CRAB”, the symbol of “WORM”, the symbol of “A”, the symbol of “K”, the symbol of “Q”, and the symbol of “J”.

When the payouts brought from these symbols are obtained on a plurality of the activated paylines, a total value of all the payouts is added to the credits.

Meanwhile, the symbol of “HUNTER” is the scatter symbol. No matter which the activated payline may be, a payout of “2” is obtained in the case of “2K” two symbols of “HUNTER” appear (are statically displayed) on the first to fifth variable display portions 21, 22, 23, 24 and 25, a payout of “5” is obtained in the case of “3K” where three symbols of “HUNTER” appear (are statically displayed) thereon, a payout of “10” is obtained in the case of “4K” where four symbols of “HUNTER” appear (are statically displayed) thereon, and a payout of “125” is obtained in the case of “5K” where five symbols of “HUNTER” appear (are statically displayed) thereon.

Note that, only with regard to the payouts brought from the symbol of “HUNTER”, the one obtained by multiplying the value of each payout shown in FIG. 8 by the number of total bets (product of the number of bets and the number of activated payline) is added to the credits. In the case where the payouts brought from the symbols other than the symbol of “HUNTER” are present at this time, the payouts concerned are also added to the credits.

Moreover, the symbol of “HUNTER” is also the trigger symbol for making the shift from the base game to the bonus game. No matter which the activated payline may be, when three or more symbols of “HUNTER” appear (are statically displayed) simultaneously on the first to fifth variable display portions 21, 22, 23, 24 and 25, a player can play the bonus game, as well as obtains the above-described payout.

Next, a description will be made of the bonus game. The bonus game in a game to be started by satisfying a specific condition during the base game, and in general, is a game advantageous for a player. When the game is shifted from the base gum to the bonus game, the player can continuously play any of 10 to 25 games in response to a lottery result at the time when the game is shifted to the bonus game without betting the credits and the like (free games).

Note that, for the number of bets and the number of activated paylines during the bonus games, the ones at the time when the game is shifted to the bonus game are used. Moreover, the winning combinations and the payouts of the winning combinations in the bonus game are the same as those of the above-described base game; however, the symbol of “SHARK” is treated as the symbol of “LOBSTER”, and when totally three or more symbols of “HUNTER” appear (are statically displayed), the number of any of 10 to 25 bonus games is further added in response to the lottery result. As a result, a period of the bonus game is extended (continued). Here, as shown in FIG. 8, in the symbol of “LOBSTER”, the payouts in the case of winning thereof are set higher as compared with those in the symbol of “SHARK”. Accordingly, there is a high possibility that, in the bonus game, the player does not consume the credits and can acquire a large amount of credits and the like in the bonus game.

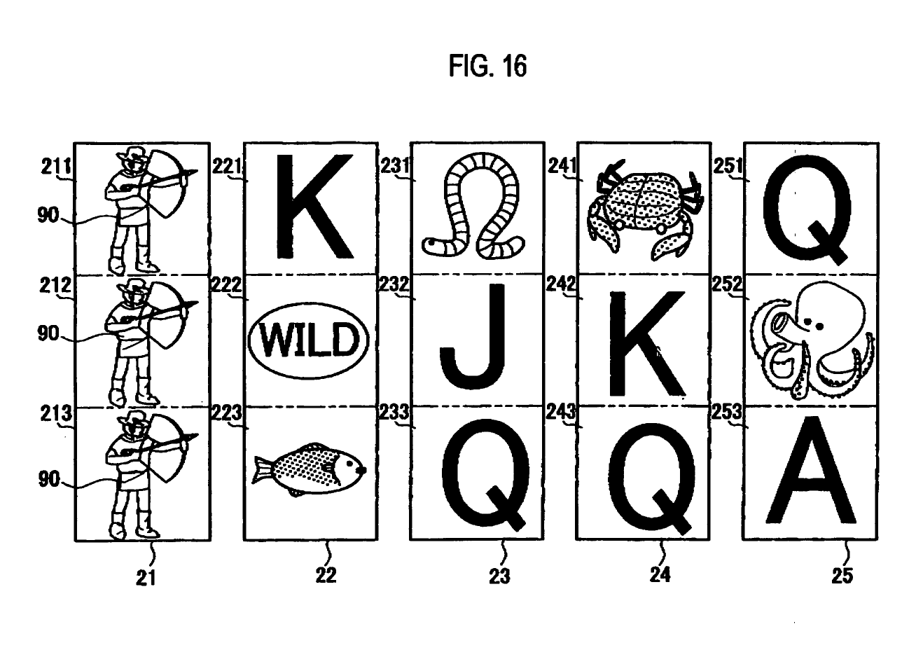

Moreover, in the slot machine 1, when the symbol of “HUNTER” is statically displayed on one of the static regions 211 to 213 of the first variable display portion 21 and three or more thereof are not statically displayed on the first to fifth variable display portions 21, 22, 23, 24 and 25 during the bonus game, display of symbols stopped on the other two of the static display regions 211 to 213 is changed to (replaced by) that of the symbols of “HUNTER” (refer to FIG. 15 and FIG. 16). Thus, three symbols of “HUNTER” are statically displayed, thereby satisfying the winning condition of the bonus game. Accordingly, the number of bonus games is increased. As a result, it becomes possible to further enhance the expectations of the player during the bonus game.

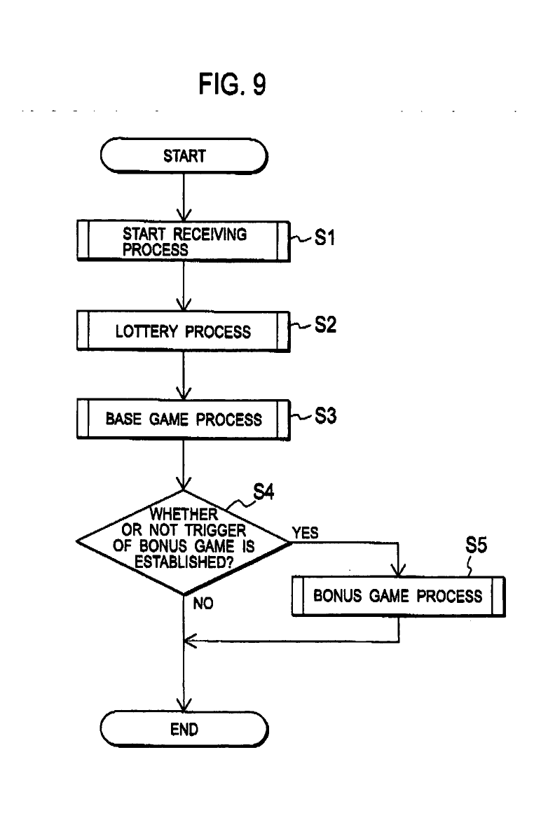

Next, a description will be made of the main process program of the slot machine 1. The programs of the processes shown in FIG. 9 to FIG. 14 are stored in the ROM 51 and the RAM 52 and executed by the CPU 50.

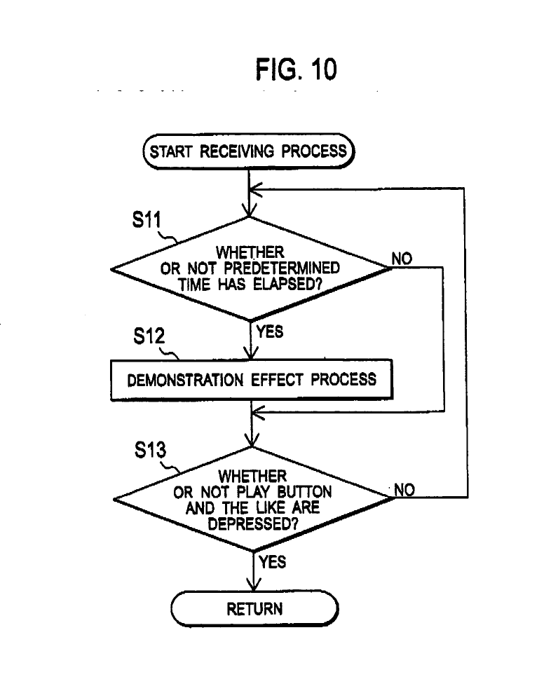

As shown in FIG. 9, in Step (hereinafter, abbreviated as “S”) 1, the CPU 50 executes a start receiving process (refer to FIG. 10). The start receiving process receives the switching signals outputted from the 1-BET switch 57, the 3-BET switch 58, or the 5-BET switch 59, and the 1-LINE switch 60, the 5-LINES switch 61, or the 20-LINES switch 62 based on the operation of the BET 1 PER LINE button 33, the operation of the BET 3 PER LINE button 34, or the operation of the BET 5 PER LINE button 35, and the operation of the PLAY 1 LINE button 37, the operation of the PLAY 5 LINES button 38, or the operation of the PLAY 20 LINES button 39. At the time when the switching signals outputted from the respective switches are received, the game is started.

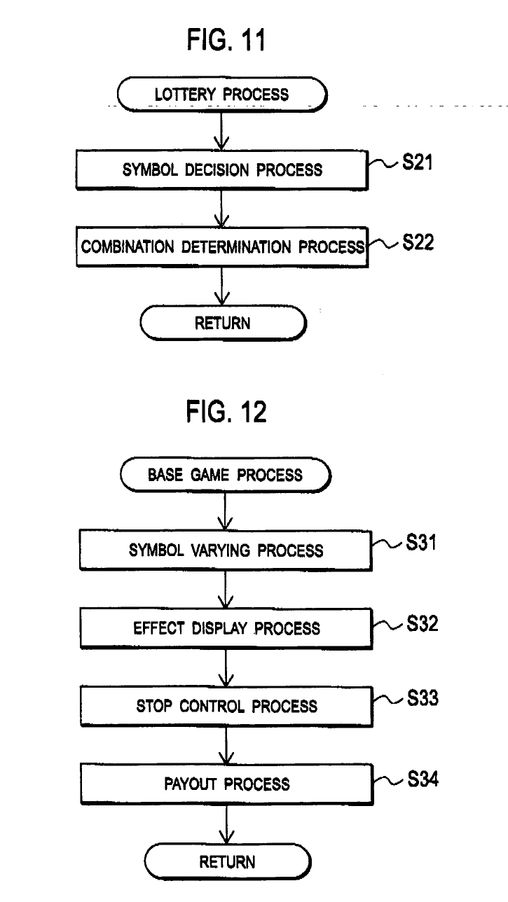

In S2, the CPU 50 executes the lottery process based on the switching signal outputted from the 1-LINE switch 60, the 5-LINES switch 61, or the 20-LINES switch 62 (refer to FIG. 11).

In S3, the CPU 50 executes the base game process. In S4, the CPU 50 determines whether or not the bonus game is won. Specifically, in the base games process in S3, the CPU 50 determines whether or not three or more symbols of “HUNTER” are statically displayed on the first to fifth variable display portions 21, 22, 23, 24 and 25. When the three or more symbols of “HUNTER” are statically displayed, the bonus games is won.

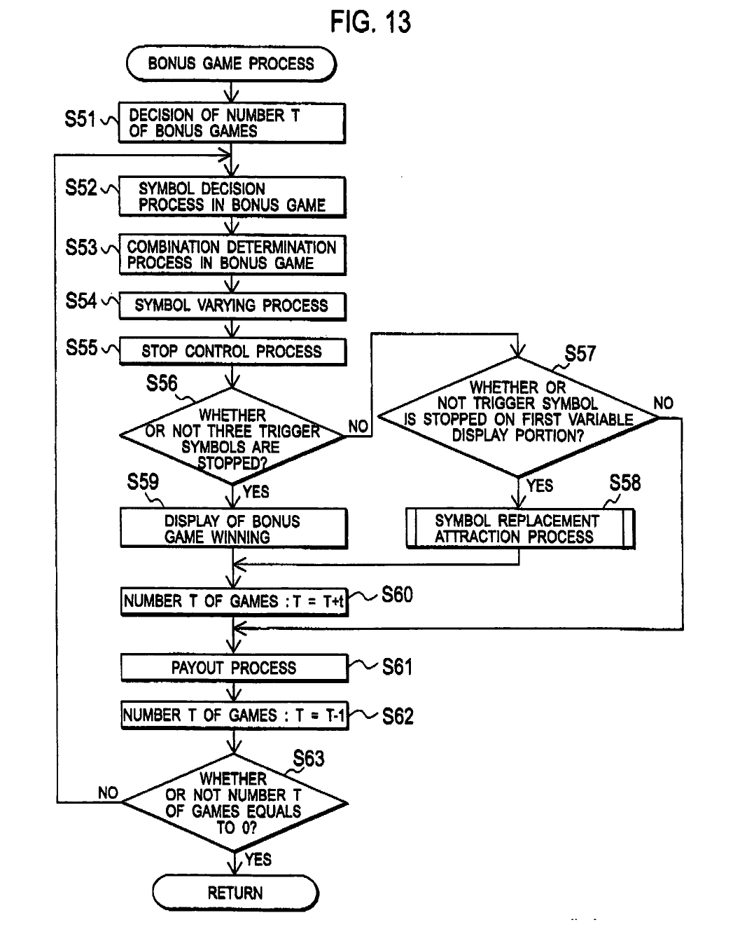

When the CPU 50 determines that the bonus game is won (S4: YES), the CPU 50 proceeds to S5, where the bonus game process is executed (refer to FIG. 13). When the CPU 50 determines that the bonus game is not won (S4: NO), the main process program is ended.

Next, a description will be made of the start receiving process.

As shown in FIG. 10, in S11, the CPU 50 determines whether or not a predetermined tine (for example, 15 seconds) has elapsed. When the CPU 50 determines that the predetermined time has not elapsed (S11: NO), the CPU 50 proceeds to S13. When the CPU 50 determines that the predetermined time has elapsed (S11: YES), the CPU 50 proceeds to S12, where a demonstration effect is displayed on the upper liquid crystal display 3 and the lower liquid crystal display 4, and then the CPU 50 proceeds to S13.

In S13, the CPU 50 determines whether or not the operation of the PLAY 1 LINE button 37, the operation of the PLAY 5 LINES button 3, or the operation of the PLAY 20 LINES button 39 has been performed. When the CPU 50 determines that the operation of the PLAY 1 LINE button 37 or the like has not been performed (S13: NO), the CPU 50 returns to S11, and the above-described processes are repeated. When the CPU 50 determines that the operation of the PLAY 1 LINK button 37 or the has been performed (S13: YES), the start receiving process is ended and the CPU 50 shifts to the lottery process (S2).

Note that, in the determination process of S13, the CPU 50 may also end the start receiving process based on other input signals than the operation signal from the PLAY 1 LINE button 37, the PLAY 5 LINES button 38, or the PLAY 20 LINES button 39.

Next, a description will be made of the lottery process.

As shown in FIG. 11, in S21, the CPU 50 executes a symbol decision process. Specifically, the CPU 50 decides the symbols to be statically displayed on the first payline L1 for each of the first to fifth variable display portions 21, 22, 23, 24 and 25 in the base game. The CPU 50 samples five random number values individually corresponding to the first to fifth variable display portions 21, 22, 23, 24 and 25 by the random number sampling circuit 56, and decides the code number from the symbol lottery table 51A. Moreover, the CPU 50 decides the 50 decides to be statically displayed for each of the first to fifth variable display portions 21, 22, 23, 24 and 25 based on the code number and the first to fifth reel bands 111, 112, 113, 114 and 115.

Upon deciding the symbols to be statically displayed on the activated payline, the CPU 50 proceeds to S22. In S22, the CPU 50 executes a combination determination process, and then shifts to the base game process (S3). In the combination determination process, the CPU 50 decides the winning combination and the payout of the winning combination based on the symbols decided in S21 and the payout table 51B of FIG. 8.

Next, a description will be made of the base game process.

As shown in FIG. 12, in S31, the CPU 50 variably displays the symbols on the first to fifth variable display portions 21, 22, 23, 24 and 25 based on the switching signal outputted from the 1-LINE switch 60, the 5-LINES switch 61, or the 20-LINES switch 62, the switching signal having been received in the start receiving process (S1). In S32, at a varying stage before the symbols are stopped on the first to fifth variable display portions 21, 22, 23, 24 and 25, the CPU 50 executes an announcement attraction process which generates an announcement attraction for announcing that the bonus game will be won at a predetermined probability.

In S33, the CPU 50 statically displays the symbols on the first to fifth variable display portions 21, 22, 23, 24 and 25. In S34, the CPU 50 pays out the credits and the like, which are equivalent to the payout decided based on the payout table 51B of FIG. 8, according to the combination of the symbols of the winning combination, which are statically displayed on the first to fifth variable display portions 21, 22, 23, 24 and 25 in S33. After executing such a payout process, the CPU 50 shifts to the determination process (S4).

Next, a description will be made of the bonus game process.

In S51, the number T of bonus games is set. The number of bonus games is selected from 10 to 25 based on the random number value sampled by the random number sampling circuit 56. The CPU 50 stores the selected number T of bonus games in the RAM 52.

In S52, the CPU 50 executes a symbol decision process in the bonus game. Specifically, the CPU 50 decides the symbols to be statically displayed on the first payline L1 for each of the first to fifth variable display portions 21, 22, 23, 24 and 25 in the bonus game. The CPU 50 samples five random number values individually corresponding to the first to fifth variable display portions 21, 22, 23, 24 and 25 by the random number sampling circuit 56, and decides the code numbers from the symbol lottery table 51A. Moreover, the CPU 50 decides the symbols to be statically displayed on the first to fifth variable display portions 21, 22, 23, 24 and 25 based on the code numbers and the first to fifth reel bands 111, 112, 113, 114 and 115.

Upon deciding the symbols to be statically displayed on the activated payline, the CPU 50 proceeds to S53. In S53, based on the symbols decided in S52 and the payout table 51B of FIG. 8, the CPU 50 decides the winning combination and the payout of the winning combination. However, in the bonus game, the symbol of “SHARK” is treated as the symbol of “LOBSTER”.

In S54, the CPU 50 executes a symbol varying process. In the symbol varying process, the CPU 50 variably displays the symbols on the first to fifth variable display portions 21, 22, 23, 24 and 25. In S55, the CPU 50 executes a stop control process. In the stop control process, the CPU 50 statically displays the symbols on the first to fifth variable display portions 21, 22, 23, 24 and 25.

In S56, the CPU 50 determines whether or not a bonus game shifting condition as the condition where the game is shifted from the base game to the bonus game is satisfied one more time in the combination determination process of S53. Specifically, the CPU 50 determines whether or not the three or more symbols of “HUNTER” are statically displayed simultaneously on the first to fifth variable display portions 21, 22, 23, 24 and 25 no matter which the activated payline may be.

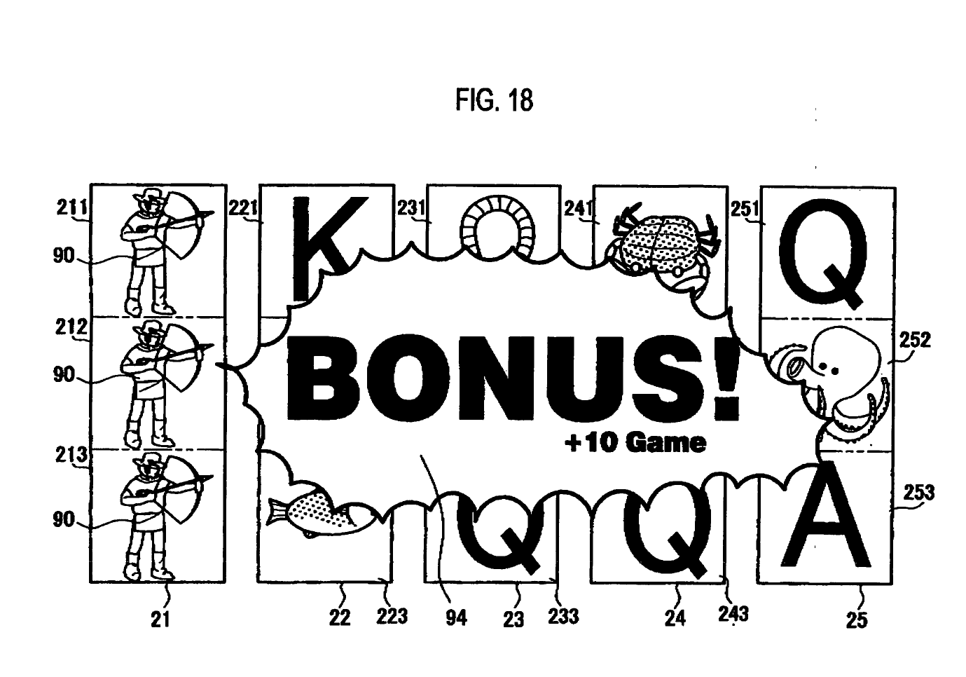

When the CPU 50 determines that the three or more symbols of “HUNTER” are statically displayed (S56: YES), the CPU 50 proceeds to S59. In S59, the CPU 50 newly decides the repeated number t of bonus games by the lottery, and displays, on the lower liquid crystal display 4, that the remaining number of bonus games is incremented by the number t by the fact that the bonus game is won again (refer to FIG. 18).

In S60, the CPU 50 adds the decided repeated number t to the current number T of bonus game. Thus, when the bonus game is won during the bonus game, the remaining number of bonus games is increased, and the period of the bonus games is extended (continued). For example, in the case where the game is shifted to 20 bonus games for the first time, when 10 bonus games are won at the twelfth one of the 20 bonus games, 18 (20−12+10) game are played. Meanwhile, in S56, when the CPU 50 determines that the three or more symbols of “HUNTER” are not statically displayed (S56: NO), the CPU 50 proceeds to S57.

In S57, the CPU 50 determines whether or not at least one symbol of “HUNTER” is statically displayed on the first variable display portion 21.

When the CPU 50 determines that the symbol of “HUNTER” is statically displayed on the first variable display portion 21 (S57: YES), the CPU 50 proceeds to S58. In S58, the CPU 50 replaces (changes) the other symbols displayed on the first variable display portion 21 by the symbol of “HUNTER”, executes a symbol replacement attraction process, and proceeds to S60.

Meanwhile, when the CPU 50 determines in S57 that the symbol of “HUNTER” is not statically displayed on the first variable display portion 21 (S57: NO), the CPU 50 proceeds to S61.

In S61, the CPU 50 executes the payout process. Specifically, according to the combination of the symbols of the winning combination, which are statically displayed on the variable display portions 21 to 25 in S55, the CPU 50 pays out the credits and the like, which are equivalent to the payout decided based on the payout table 51B of FIG. 12. In the payout table 51B, the symbol of “SHARK” is treated as the symbol of “LOBSTER” in the bonus game.

In S62, the CPU 50 reads out the number T of bonus games, which is stored in the RAM 52, and subtracts “1” from a value of the read number T of bonus games. Then, the CPU 50 stores the number T of bonus games, from which “1” is subtracted, in the RAM 52 one more time.

In S63, the CPU 50 determines whether or not the number T of bonus games has reached the number decided in S51. Specifically, the CPU 50 determines whether or not the number T of bonus games, which is stored in the RAM 52, has reached “0”. When the CPU 50 determines that the number T of bonus games is not “0” (S63: NO), the CPU 50 returns to S52, and repeats the above-described processes. Meanwhile, when the CPU 50 determines that the number T of bonus games is “0” (S63: YES), the CPU 50 ends the bonus game process program.

Next, a description will be made of a sub-process of the symbol replacement attraction process.

In S71, the CPU 50 replaces, by the symbol of “HUNTER”, the other symbols than the symbol of “HUNTER” among the three symbols statically displayed on the first variable display portion 21.

As shown in FIG. 15, for example, when a symbol 90 of “HUNTER” is statically displayed on the second static display region 212 of the first variable display portion 21, a symbol 95 of “J” and a symbol 96 of “CRAB”, which are statically displayed on the first static display region 211 and the third static display region 213, respectively, are replaced by the symbols 90 of “HUNTER”. As a result, as in FIG. 16, three symbols 90 of “HUNTER” as the winning condition of the bonus game are statically displayed on the first to third static display regions 211, 212 and 213 of the first variable display portions 21.

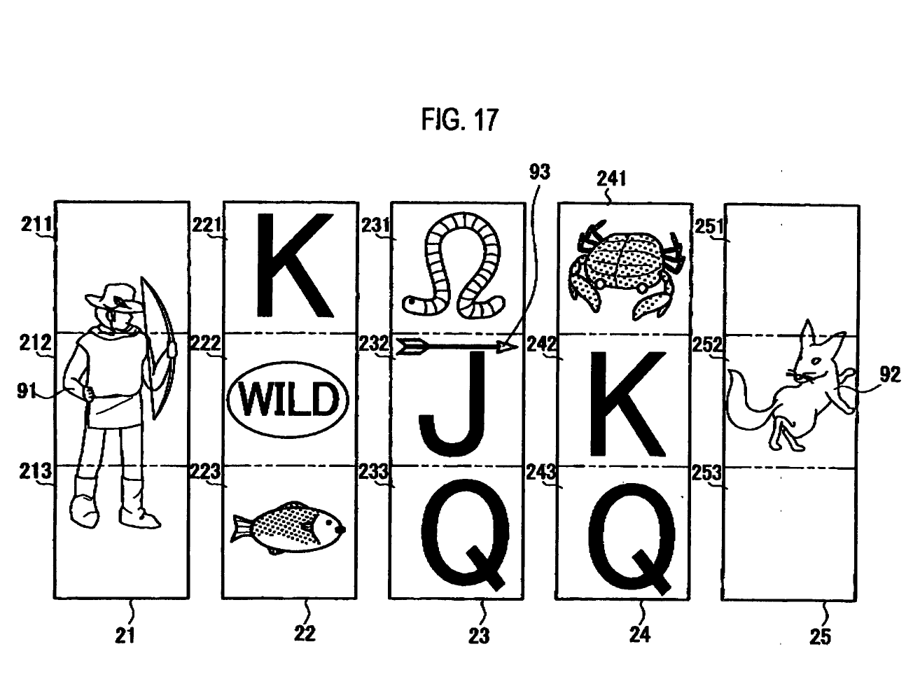

In S72, the CPU 50 once erases the three symbols 90 of “HUNTER” displayed on the first variable display portion 21 on which the three symbols 90 of “HUNTER” are displayed. Then, the CPU 50 displays an enlarged symbol 91 of HUNTER using the first to third static display regions 211, 212 and 213. Simultaneously, the CPU 50 displays an image 92 of a target game on the fifth variable display portion 25. In S73, on the lower liquid crystal display 4, a moving image effect is displayed, in which the enlarged symbol 91 of “HUNTER” displayed on the first variable display portion 21 shoots the target game 92 displayed on the fifth variable display portion 25 by an arrow 93 (refer to FIG. 17).

In S74, by the lottery, the CPU 50 newly decides the repeated number t of bonus games in response to that the three symbols of “HUNTER” are statically display simultaneously on the first variable display portion 21 by the symbol replacement of S71 to thus satisfy the winning condition of the bonus game. Then, the CPU 50 displays, on the lower liquid crystal display 4, that the remaining number of bonus games is increased by the number t owing to the fact that the bonds game is won one more time.

As shown in FIG. 18, the CPU 50 displays a bonus winning display portion 94 on approximate centers of the first to fifth variable display portions 21, 22, 23, 24 and 25. On the bonus winning display portion 94, there are displayed characters of “BONUS” showing that the bonus game is won one more time, and the number (10 in FIG. 18) of bonus games to be added.

After the bonus winning is displayed, the CPU 50 returns to S60, where the repeated number t of bonus games, which is decided by the lottery, is added to the current number T of bonus games.

Next, a description will be made of advantageous features of the slot machine 1.

First, in the slot machine 1, a case is supposed, where, during the bonus game process, at least one symbol of “HUNTER” as the trigger symbol is statically displayed on the first variable display portion 21 even if three or more symbols thereof are not statically displayed simultaneously on the first to fifth variable display portions 21, 22, 23, 24 and 25 no matter which the activated payline may be. In this case, the CPU 50 replaces (changes) the other symbols displayed on the first variable portion 21 by the symbols of “HUNTER”. Thus, the CPU 50 allows the winning of the bonus game, and increases the remaining number of bonus games. Accordingly, the slot 1 enhances the expectations of a player for another winning of the bonus game during the bonus game. Hence, as compared with the conventional slot machine, the slot machine 1 further enhances the expectations of the player for the bonus game, and enhances a gaming will thereof. Moreover, the CPU 50 changes the symbol stopped once to the trigger symbol, and redisplays the symbol formed by enlarging the trigger symbol on the first variable display portion 21. Accordingly, the slot machine 1 never bores the player by using the variety of effects.

### Second Embodiment

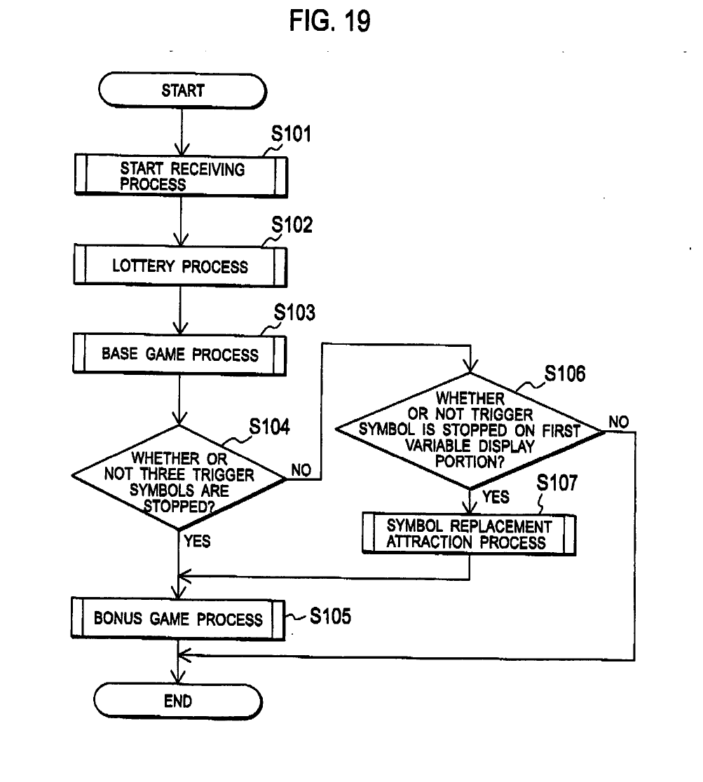

Next, a description will be made of a slot machine according to a second embodiment based on FIG. 19. Note that, in the following description, the same reference numerals as those assigned to the constituents of the slot machine 1 according to the first embodiment shown in FIG. 1 to FIG. 18 denote the same or equivalent portions as or to the constituents of the slot machine 1 according to the first embodiment.

A schematic configuration of the slot machine according to the second embodiment is substantially the same as the configuration of the slot machine 1 according to the first embodiment. Moreover, various control processes according to the second embodiment are also substantially the same as the control processes of the slot machine 1 according to the first embodiment. However, the slot machine according to the second embodiment is different from the slot machine 1 according to the first embodiment in the following point. During the bonus game process, when at least one symbol of “HUNTER” as the trigger symbol is statically displayed on the first variable display portion 21, the slot machine 1 according to the first embodiment replaces the other symbols, thereby winning the bonus game. As opposed to this, also during the base game, when at least one symbol of “HUNTER” as the trigger symbol is statically displayed on the first variable display portion 21, the slot machine according to the second embodiment replaces the other symbols, thereby winning the bonus game.

A description will be made of a main process program of the slot machine according to the second embodiment with reference to FIG. 19. Note that the respective programs in a flowchart of FIG. 19 are stored in the ROM 51 and RAM 52 of the slot machine according to the second embodiment, and are executed by a CPU 50.

In S101, the CPU 50 executes a start receiving process. In S102, the CPU 50 executes a lottery process based on a switching signal outputted from a 1-LINE switch 60, a 5-LINES switch 61, or a 20-LINES switch 62. In S103, the CPU 50 executes the base game process.

In S104, the CPU 50 determines whether or not the bonus game is won. Specifically, the CPU 50 determines whether or not three or more symbols of “HUNTER” as the trigger symbols of the bonus game are statically displayed on first to fifth variable display portions 21, 22, 23, 24 and 25 no matter which the activated payline may be.

When the three or more symbols of “HUNTER” are statically displayed (S104: YES), the CPU 50 proceeds to S105. In S105, the CPU 50 executes the bonus game.

Meanwhile, when the three or more symbols of “HUNTER” are not statically displayed, the CPU 50 proceeds to S106. In S106, the CPU 50 determines whether or not at least one symbol of “HUNTER” is statically displayed on the first variable display portion 21.

When at least one symbol of “HUNTER” is statically on the first variable display portion 21 (S106; YES), the CPU 50 replaces (changes) other symbols than the symbol of “HUNTER”, which are displayed on the first variable display portion 21, by the symbols of “HUNTER”, and executes the symbol replacement attraction process.

Thereafter, the CPU 50 proceeds to S105, and executes the bonus game process. Meanwhile, when no symbol of “HUNTER” is statically displayed (S106: NO), the CPU 50 does not win the bonus game, and ends the main process program.

In the slot machine according to the second embodiment, a case is supposed, wherein, during the base game, at least one symbol of “HUNTER” as the trigger symbol is statically displayed on the first variable display portion 21 even if three or more symbols thereof are not statically displayed simultaneously on the first to fifth variable display portions 21, 22, 23, 24 and 25 no matter which the activated payline may be. In this case, the CPU 50 replaces (changes) the other symbols displayed on the first variable display portion 21 by the symbols of “HUNTER”, Thus, the CPU 50 allows the winning of the bonus game, and executes the bonus game process. Accordingly, the slot machine enhances the expectations of a player for such generation of the bonus game during the base game. Hence, the slot machine further enhances the expectations of the player for the winning of the bonus game during the base game, and enhances the gaming will thereof.

Moreover, the CPU 50 changes the symbol stopped once to the trigger symbol, and accordingly, the slot machine never bores the player by using the variety of effects.

Furthermore, as in the first embodiment, in the slot machine according to the second embodiment, when at least one symbol of “HUNTER” as the trigger symbol is statically displayed on the first variable display portion 21 even during the bonus game process, the other symbols than the symbol of “HUNTER”, which are displayed on the first variable display portion 21, are replaced (changed) by the symbols of “HUNTER”. Thus, the CPU 50 allows the winning of the bonus game, and increases the remaining number of bonus games. Accordingly, the slot machine enhances the expectations of a player for another winning of the bonus game during the bonus game. Hence, the slot machine further enhances the expectations of the player for the bonus game, and enhances the gaming will thereof.

### Third Embodiment

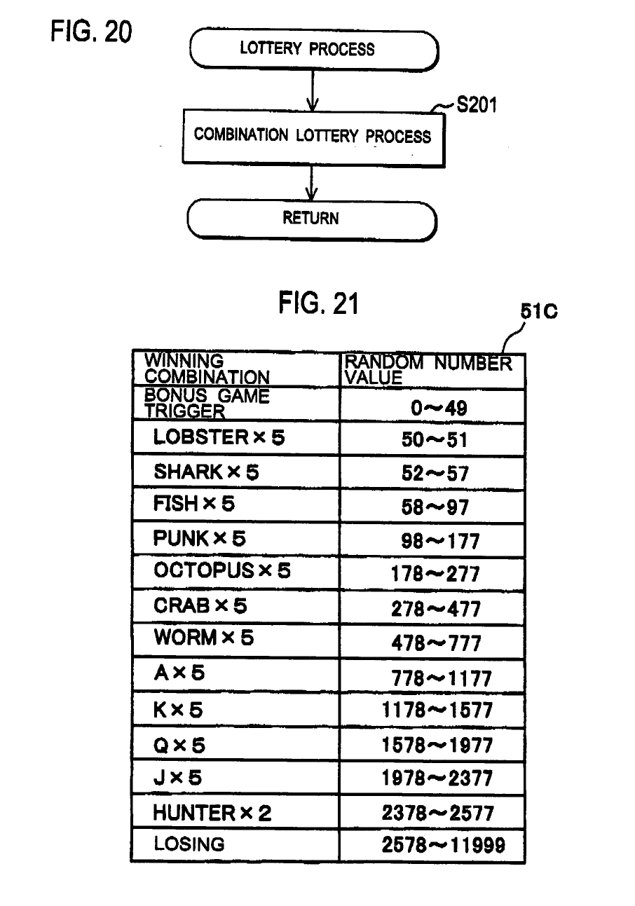

Next, a description will be made of a slot machine according to a third embodiment with reference to FIG. 20 and FIG. 21. Note that, in the following description, the same reference numerals as those assigned to the constituents of the slot machine 1 according to the first embodiment shown in FIG. 1 to FIG. 18 denote the same or equivalent portions as or to the constituents of the slot machine 1 according to the first embodiment.

A schematic configuration of the slot machine according to the third embodiment is substantially the same as the configuration of the slot machine 1 according to the first embodiment. Moreover, various control processes of the slot machine according to the third embodiment are also substantially the same as the control processes of the slot machine 1 according to the first embodiment.

However, the slot machine according to the third embodiment is different from the slot machine 1 according to the first embodiment in the following point. In the case of controlling to stop the symbols on the first to fifth variable display portions 21, 22, 23, 24 and 25, the slot machine 1 according to the first embodiment samples the five random number values individually corresponding to the first to fifth variable display portions 21, 22, 23, 24 and 25 by the random number sampling circuit 56. In addition, based on the code numbers decided by the random number values thus obtained and the symbol lottery table 51A and on the first to fifth reel strips 111, 112, 113, 114 and 115, the slot machine 1 decides the symbols to be stopped. Furthermore, based on the symbols thus statically displayed and the payout table 51B of FIG. 12, the slot machine 1 decides the winning combination and the payout of the winning combination. As opposed to this, the slot machine according to the third embodiment decides the winning combination directly based on the random number value.

A description will be made of a lottery process executed by S2 of the main process program in the slot machine according to the third embodiment with reference to FIG. 20. Note that a program for a process shown in a flowchart of FIG. 20 is stored in the ROM 51 and RAM 52 of the slot machine according to the third embodiment, and executed by the CPU 50.

In S201, the CPU 50 executes the combination lottery process. Specifically, in the base game, the lottery of the winning combination of the symbols statically displayed on the first to fifth variable display portions 21, 22, 23, 24 and 25 is performed by using a winning combination lottery table 51C. Upon deciding the winning combination, the CPU 50 shifts to the base game process (S3). In the base game process, the CPU 50 statically displays the symbols based on the decided winning combination.

Next, a description will be made of the winning combination lottery table 51C for use in the combination lottery process.

As shown in FIG. 21, a range of random number values for use in the winning combination lottery table 51C is 0 to 11999. When the random number sampled through the random number sampling circuit 56 is in a range of 0 to 49, the trigger of the bonus game is won. In this case, the CPU 50 statically displays three or more symbols of “HUNTER” simultaneously no matter which the payline may be, and shifts to the bonus games or increases the remaining number of bonus games. However, in the case where the bonus game process is under execution, and where the random number value is in a range of 30 to 49, the CPU 50 statically displays the symbol of “HUNTER” on the first variable display portion, and then executes the above-described symbol replacement attraction process which changes the other symbols than the symbol of “HUNTER” to the symbols of “HUNTER”, thereby increasing the remaining number of bonus games.

When the random number value sampled through the random number sampling circuit 56 is in a range of 50 to 51, the winning combination of “LOBSTER” is won. In this case, the CPU 50 statically displays five symbols of “LOBSTER” on the activated payline. When the random number value sampled through the random number sampling circuit 56 is in a range of 52 to 57, the winning combination of “SHARK” is won. In this case, the CPU 50 statically displays five symbols of “SHARK” on the activated payline. In a similar way to the above, when the random number value is in a range of 58 to 97, the winning combination of “FISH” is won. When the random number value is in a range of 98 to 177, the winning combination of “PUNK” is won. When the random number value is in a range of 178 to 277, the winning combination of “OCTOPUS” is won. When the random number value is in a range of 278 to 477, the winning combination of “CRAB” is won. When the random number value is in a range of 478 to 777, the winning combination of “WORM” is won. When the random number value is in a range of 778 to 1177, the winning combination of “A” is won. When the random number value is in a range of 1178 to 1577, the winning combination of “K” is won. When the random number value is in a range of 1578 to 1977, the winning combination of “Q” is won. When the random number value is in a range of 1978 to 2377, the winning combination of “J” is won. Moreover, when the random number value is in a range of 2377 to 2577, two symbols of “HUNTER” are statically displayed no matter which the payline may be.

Meanwhile, when the random number value sampled through the random number sampling circuit 56 is in a range of 2578 to 11999, losing is decided, and the CPU 50 statically displays a combination of losing symbols, which does not apply to the combination of any of the above-described winning combinations.

In the slot machine according to the third embodiment, when at least one symbol of “HUNTER” is statically displayed on the first variable display portion 21 even during the bonus games process, the other symbols than the symbol of “HUNTER”, which are displayed on the first variable display portion 21, are replaced (changed) by the symbols of “HUNTER”. Thus, the CPU 50 allows the winning of the bonus game, and increases the remaining number of bonus games. Accordingly, the slot machine enhances the expectations of a player for another winning of the bonus game during the bonus game. Hence, the slot machine further enhances the expectations of the player for the bonus game, and enhances the gaming will thereof.

Note that the present invention is not the one limited to the above-described embodiments, and various improvements and modifications are possible within the scope without departing from the gist of the present invention.

For example, even if the three or more symbols of “HUNTER” as the trigger symbols of the bonus game are not statically displayed simultaneously, when at least one symbol thereof is statically displayed on the first variable display portion 21, each of the slot machines according to the first to third embodiments replaces the other symbols than the symbol of “HUNTER”, which are statically displayed on the first variable display portion 21, by the symbols of “HUNTER”, and allows the winning of the bonus game. However, the variable display portion on which the above-described replacement is to be performed is not limited to the first variable display portion 21. Also when the at least one trigger symbol is statically displayed on the second variable display portion 22 or the third variable display portion 23, the CPU 50 may replace the other symbols than the symbol of “HUNTER”, which are statically displayed on the above-described variable display portion other than the first variable display portion 21, by the symbols of “HUNTER”, and may allow the winning of the bonus game.

Moreover, also when the at least one trigger symbol is statically displayed on at least one of the first to fifth variable display portions 21, 22, 23, 24 and 25, the CPU 50 may allow the winning of the bonus game. For example, when the trigger symbols are statically displayed one by one on the second variable display portions 22 and the fourth variable display portions 24, such an effect display which replaces the symbols may be performed on only one of the second variable display portion 22 and the fourth variable display portion 24 or on both thereof.

Furthermore, each of the slot machines according to the first to third embodiments statically displays three symbols on each of the first to fifth variable display portions 21, 22, 23, 24 and 25, that is, totally 15 symbols, and determines the winning based on the combination of the symbols thus statically displayed. However, each of the slot machines may statically display five symbols on each of the first to fifth variable display portions 21, 22, 23, 24 and 25, that is, totally 25 symbols, and may determine the winning based on a combination of the symbols thus statically displayed. In this case, when the trigger symbol of the bonus game is statically displayed on the first variable display portion 21, the CPU 50 replaces four symbols other than the trigger symbol, which are statically displayed on the first variable display portion 21, by the trigger symbols, and generates the bonus game.

Moreover, in the first to third embodiments, when the bonus game is won one more time during the bonus game, the CPU 50 newly adds the predetermined number of bonus games to the current remaining number of bonus games. However, the CPU 50 may newly start the predetermined number of bonus games.

What is claimed is:

1. A gaming machine comprising:
a display configured to variably display a plurality of symbols and
a processor operably coupled to at least one of the display and a memory,
the processor
statically displaying the plurality of symbols on the display,
executing a game according to a plurality of gaming modes including a base gaming mode and a special gaming mode which gives a player a condition more advantageous than a condition of the base gaming mode, and
replacing, by one or more special symbols, one or more symbols equivalent to the number of insufficient special symbols required for continuing a game period of the special gaming mode, from among one or more displayed symbols except for one or more special symbols statically displayed on the display, in the special gaming mode, and continuing the game period of the special gaming mode.

2. The gaming machine according to claim 1, wherein when the one or more symbols are replaced by the one or more special symbols, the processor displays an image associated with the special symbols on the display on which the replaced special symbols are displayed.

3. The gaming machine according to claim 1, comprising a plurality of reels each on which the plurality of symbols are mounted,
wherein when one or more special symbols on one column corresponding to any of the reels are statically displayed on the display, the processor replaces, by one or more special symbols, one or more display symbols except for the one or more special symbols on the one column.

4. A gaming machine comprising:
a display configured to variably display a plurality of symbols and
a processor operably coupled to at least one of the display and a memory,
the processor
statically displaying the plurality of symbols on the display,
executing a game according to a plurality of gaming modes including a base gaming mode and a special gaming mode which gives a player a condition more advantageous than a condition of the base gaming mode, and
replacing, by one or more special symbols, one or more symbols equivalent to the number of insufficient special symbols required for shifting the gaming mode to the special gaming mode, from among one or more displayed symbols except for one or more special symbols statically displayed on the display, in the base gaming mode, and shifting the gaming mode from the base gaming mode to the special gaming mode.

5. The gaming machine according to claim 4, wherein the processor
continues a game period of the special gaming mode when a predetermined number of special are statically displayed among the symbols statically displayed on the display in the special gaming mode;
replaces, by one or more special symbols, one or more symbols equivalent to the number of insufficient special symbols required for continuing the gaming period of the special gaming mode, from among one or more displayed symbols except for one or more special symbols statically displayed on the display, in the special gaming mode, and continuing the game period of the special gaming mode.

6. The gaming machine according to claim 4, wherein when the one or more symbols are replaced by the one or more special symbols, the processor displays an image associated with the special symbols on the display on which the replaced special symbols are displayed.

7. The gaming machine according to claim 5, wherein when the one or more symbols are replaced by the one or more special symbols, the processor displays an image associated with the special symbols on the display on which the replaced special symbols are displayed.

8. The gaming machine according to claim 4, further comprising a plurality of reels each on which the plurality of symbols are mounted,
wherein when one or more special symbols on one column corresponding to any of the reels are statically displayed on the display, the processor replaces, by one or more special symbols, one or more display symbols except for the one or more special symbols on the one column.

9. A gaming machine comprising:
a display configured to variably display a plurality of symbols and
a processor operably coupled to at least one of the display and a memory,
the processor
statically displaying the plurality of symbols on the display,
executing a game according to a plurality of gaming modes including a base gaming mode and a special gaming mode which gives a player a condition more advantageous than a condition of the base gaming mode, and
replacing, by one or more special symbols, one or more symbols equivalent to the number of insufficient special symbols required for continuing a game period of the special gaming mode, from among one or more displayed symbols except for one or more special symbols statically displayed on the display, in the special gaming mode, displaying an image associated with the special symbols on the display on which the replaced special symbols are displayed, and continuing the game period of the special gaming mode.

10. The gaming machine according to claim 9, further comprising a plurality of reels each on which the plurality of symbols are mounted,
wherein when one or more special symbols on one column corresponding to any of the reels are statically displayed on the display, the processor replaces, by one or more special symbols, one or more displayed symbols except for the one or more special symbols on the one column.
